(19) United States
(12) Patent Application Publication
(10) Pub. No.: US 2026/0304012 A1
(43) Pub. Date: Oct. 1, 2026

(54) OPTICAL LINK MONITORING APPARATUS AND METHOD FOR OPTICAL COMMUNICATION NETWORK

(71) Applicant: ELECTRONICS AND TELECOMMUNICATIONS RESEARCH INSTITUTE, Daejeon (KR)

(72) Inventors: Han-Hyub LEE, Daejeon (KR); Hwan-Seok CHUNG, Daejeon (KR)

(73) Assignee: ELECTRONICS AND TELECOMMUNICATIONS RESEARCH INSTITUTE, Daejeon (KR)

(21) Appl. No.: 19/633,743

(22) Filed: Mar. 30, 2026

(30) Foreign Application Priority Data
Mar. 31, 2025 (KR) 10-2025-0041027
Mar. 9, 2026 (KR) 10-2026-0042034

(51) Int. Cl. H04Q 11/00; H04B 10/071; H04L 41/0631

(52) U.S. Cl. CPC H04Q 11/0067; H04B 10/071; H04L 41/0631; H04Q 2011/0083; H04Q 2213/054

(57) ABSTRACT

Disclosed herein are an optical link monitoring apparatus and method. The optical link monitoring apparatus and method are configured to identify a root cause of faults in an optical link while distinguishing between loss and reflection by combining signal quality metrics with received optical power.

### CROSS REFERENCE TO RELATED APPLICATIONS

This application claims the benefit of Korean Patent Application Nos. 10-2025-0041027, filed Mar. 31, 2025 and 10-2026-0042034, filed Mar. 9, 2026, which are hereby incorporated by reference in their entireties into this application.

### BACKGROUND OF THE INVENTION

### 1. Technical Field

The following embodiments relate to a technology for monitoring the performance of an optical link in an optical communication network.

### 2. Description of the Related Art

As the speed of an optical communication network increases, monitoring the state of an optical link connecting optical transmission devices has become very important. Monitoring of optical links for optical access networks used to deliver high-speed optical signals to subscribers, as well as optical links connecting telecommunications offices, data centers, and wireless base stations, is also important.

The optical links for optical access networks include a feeder optical fiber connecting subscribers to a central office, a multi-stage passive splitter, a distribution optical fiber, and a drop optical fiber, and are considerably complex due to a geographically widely distributed network structure.

Such components are interconnected through multiple fusion splices and optical connectors, which are major factors that increase loss and reflection in the optical links.

As the speed of optical signals increases, the influence of optical link loss and reflection on the quality of optical signals becomes greater, and thus the need to monitor loss and reflection of the optical links is also increasingly emphasized, and research into various optical link monitoring technologies is conducted and used.

A typical optical link monitoring method is to use Optical Time-Domain Reflectometry (OTDR) to inspect loss along an optical cable. OTDR-based techniques include correlation detection for an improved dynamic range, wavelength-tunable OTDR using fiber Bragg gratings, and a method of installing a remotely powered splitter for branch-wise monitoring. These methods are effective in measuring loss changes of optical links and finding reflection positions, but it is difficult to measure the quality of optical signals attributable to the loss and reflection of optical links.

As another method, when an optical transceiver used in an optical transmission/reception device is utilized, techniques have been employed to monitor the variation in the intensity of a received optical signal by using an operating current of a photodetector used in an optical reception unit of the optical transceiver or a Received Signal Strength Indicator (RSSI) in a Transimpedance Amplifier (TIA) connected to a rear stage of the photodetector. By utilizing this technology, changes in optical link loss may be estimated.

However, because this technology measures only the variation in the mean optical intensity of the optical signal, there is a limitation in that only changes in optical link loss can be detected.

### SUMMARY OF THE INVENTION

An embodiment is intended to detect not only the change in optical link loss but also the change in reflectance by utilizing the results of monitoring the quality of optical signals using an optical transceiver that is employed in an optical transmission/reception device.

An embodiment is intended to exchange the results of measuring state changes of an optical link between optical transmission/reception devices and rapidly diagnose faults in the optical link using the exchanged results.

In accordance with an aspect, there is provided an optical link monitoring method, including identifying a root cause of faults in an optical link while distinguishing between loss and reflection by combining signal quality metrics with received optical power.

The signal quality metrics may be extracted by an equalizer.

The received optical power may be acquired by a photodiode.

The signal quality metrics may include at least one of an amplitude, a Signal-to-Noise Ratio (SNR) or an eye height of a received optical signal, or a combination thereof.

The optical link monitoring method may further include, when both signal quality and optical power change, determining that loss of the optical link has occurred, and when only signal quality changes without a change in optical power, determining that reflection of the optical link has occurred.

The signal quality metrics and the received optical power may be acquired from an optical reception unit, the optical reception unit may include a photodiode configured to convert a received optical signal into an electrical signal, and an equalizer configured to convert the electrical signal into a digital signal, adjust a frequency response of the digital signal, and then reshape the adjusted digital signal in a desired form, the equalizer may extract the signal quality metrics, and the photodiode may acquire the received optical power.

The equalizer may be configured to extract histograms for respective levels by analyzing an eye diagram of an input digital signal, calculate an intensity and noise of the input digital signal based on the histograms for respective levels, and then measure a Signal-to-Noise Ratio (SNR) or an eye height.

The equalizer may be controlled to minimize the noise.

In accordance with another aspect, there is provided an optical link monitoring apparatus, including memory configured to store at least one program, and a processor configured to execute the program, wherein the program is configured to identify a root cause of faults in an optical link while distinguishing between loss and reflection by combining signal quality metrics with received optical power.

The signal quality metrics may be extracted by an equalizer.

The received optical power may be acquired by a photodiode.

The signal quality metrics may include at least one of an amplitude, a Signal-to-Noise Ratio (SNR) or an eye height of an optical signal, or a combination thereof.

The program may be configured to, when both signal quality and optical power change, determine that loss of the optical link has occurred, and when only signal quality changes without a change in optical power, determine that reflection of the optical link has occurred.

Here, the signal quality metrics and the received optical power may be acquired from an optical reception unit, and the optical reception unit may include a photodiode configured to convert a received optical signal into an electrical signal, and an equalizer configured to convert the electrical signal into a digital signal, adjust a frequency response of the digital signal, and then reshape the adjusted digital signal in a desired form, the equalizer may extract the signal quality metrics, and the photodiode may acquire the received optical power.

The equalizer may be configured to extract histograms for respective levels by analyzing an eye diagram of an input digital signal, calculate an intensity and noise of the input digital signal based on the histograms for respective levels, and then measure a Signal-to-Noise Ratio (SNR) or an eye height.

The equalizer may be controlled to minimize noise.

The program may be configured to determine faults from a result of monitoring the optical link based on pre-trained artificial intelligence.

In accordance with a further aspect, there is provided a method for monitoring an optical link between optical transmission devices, including monitoring, by an optical transceiver of first optical transmission equipment, an optical link, loading, by the first optical transmission equipment, an optical link monitoring result related to changes in optical signal quality and optical signal intensity from the optical transceiver, reconstructing, by the first optical transmission equipment, the optical link monitoring result to conform to a predefined data format, transmitting, by the first optical transmission equipment, data including the optical link monitoring result to second optical transmission equipment, receiving, by the second optical transmission equipment, the data and loading the optical link monitoring result, and determining, by the second optical transmission equipment, a state of the optical link using the optical link monitoring result.

The optical link monitoring information loaded from the optical transceiver may include transmitted optical power (Tx Power), received optical power (Rx Power), a laser bias current, a module temperature or a module voltage, or a combination thereof.

The optical link monitoring result may further include quality information of a received optical signal, and the quality information of the received optical signal includes at least one of a Signal-to-Noise Ratio (SNR) or an eye height, or a combination thereof.

Here, the second optical transmission equipment may determine the state of the optical link using monitoring results of other systems collected for system operation together with the optical link monitoring result of the first optical transmission equipment.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a configuration diagram of a Time Division Multiplexing Passive Optical Network (TDM-PON) to which an embodiment is applied;

FIG. 2 is a configuration diagram of a system to which an optical link monitoring apparatus according to an embodiment is applied;

FIG. 3 is a schematic block diagram illustrating the internal configuration of an optical transceiver according to an embodiment;

FIG. 4 is a flowchart for explaining an optical link monitoring method according to an embodiment;

FIG. 5 is a diagram illustrating an example of a signal level and noise magnitude measured to calculate an SNR and an eye height in an eye diagram;

FIG. 6 is a diagram illustrating an example of the change in the current value of a photodiode according to the change in optical link loss;

FIG. 7 is a diagram illustrating an example of the SNR value of a monitored optical signal according to the change in optical link loss;

FIG. 8 illustrates an example of an eye diagram when reflection of an optical link is small;

FIG. 9 illustrates an example of an eye diagram when reflection of an optical link is large;

FIG. 10 is a diagram illustrating an example of the results of simultaneously measuring monitored current and eye height with respect to changes in loss and reflectance of an optical link;

FIG. 11 is a signal flowchart for explaining a method for transmitting/receiving the results of monitoring an optical link between optical transmission devices according to another embodiment; and

FIG. 12 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

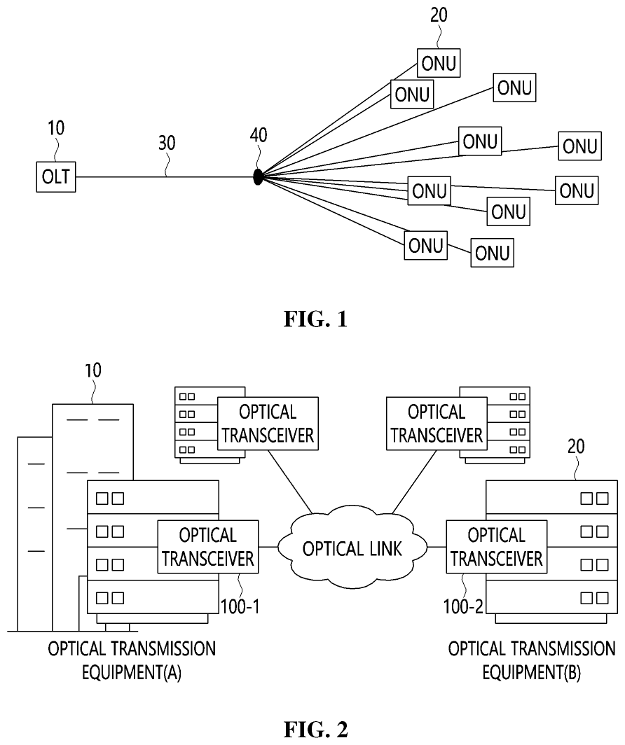

FIG. 1 is a configuration diagram of an Optical Distribution Network (ODN) to which an embodiment is applied.

Referring to FIG. 1, in the Optical Distribution Network (ODN), an Optical Line Terminal (OLT) 10 located in a telecommunications office and Optical Network Units (ONUs) 20 used on a subscriber side may be connected through an optical link composed of an optical line 30 and an optical splitter 40.

Here, the distances between the OLT 10 and the ONUs 20 may range to a maximum of 20 km, and distances between the respective ONUs 20 and the OLT 10 may be equal to each other.

An embodiment may perform optical link monitoring through an optical transceiver in the optical network such as that illustrated in FIG. 1.

FIG. 2 is a configuration diagram of a system to which an optical link monitoring apparatus according to an embodiment is applied.

Referring to FIG. 2, the system to which the optical link monitoring apparatus according to an embodiment is applied may include optical transmission devices (optical transmission devices) 10 and 20 which exchange optical communication signals with each other.

Here, the optical transmission equipment (A) 10 may be equipment located at a telecommunications office, such as the OLT 10 illustrated in FIG. 1, and the optical transmission equipment (B) 20 may be equipment located at a remote place outside the telecommunications office, such as the ONU 20 illustrated in FIG. 1.

Further, the optical transmission devices 10 and 20 may be servers located in a data center, and may be transmission equipment used in the telecommunications office and a wireless base station.

In the optical transmission devices 10 and 20, optical transceivers 100-1 and 100-2 which transmit and receive optical signals are installed, respectively, and may be connected to each other through an optical link.

Here, the optical link may be configured in a point-to-point or point-to-multipoint form.

Also, the optical transceivers 100-1 and 100-2 may convert electrical signals output from the optical transmission devices 10 and 20 into optical signals and transmit the optical signals through the optical link, or may convert optical signals input from the optical link into electrical signals and deliver the electrical signals to the optical transmission devices 10 and 20.

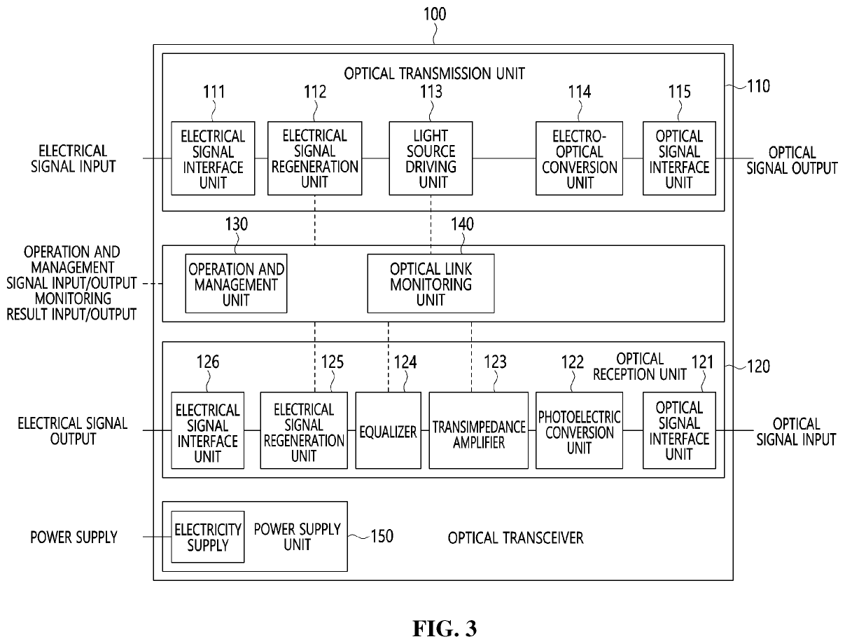

FIG. 3 is a schematic block diagram illustrating the internal configuration of an optical transceiver according to an embodiment.

Referring to FIG. 3, an optical transceiver 100 according to an embodiment may include an optical transmission unit 110, an optical reception unit 120, an operation and management unit 130, an optical link monitoring unit 140, and a power supply unit 150.

In detail, the optical transmission unit 110 may include an electrical signal interface unit 111 which receives an electrical signal, an electrical signal regeneration unit 112 which recovers timing or the like of the electrical signal, a light source driving unit 113 which receives the electrical signal and amplifies the amplitude of the electrical signal to drive an electro-optical conversion unit 114, the electro-optical conversion unit 114 which converts the electrical signal into an optical signal using a semiconductor laser diode used as a light source, and an optical signal interface unit 115 which connects the output of the electro-optical conversion unit 114 to the optical link.

Here, the electrical signal regeneration unit 112 and the light source driving unit 113 may be implemented as a single block. Also, the electro-optical conversion unit 114 and the optical signal interface unit 115 may be implemented as a single block.

Furthermore, the optical reception unit 120 may include an optical signal interface 121 which inputs an optical signal output from the optical link to a photoelectric conversion unit (e.g., a photodiode) 122, the photoelectric conversion unit 122 which converts the input optical signal into an electrical signal through a photodiode, a Transimpedance Amplifier (TIA) 123 which amplifies the amplitude of the converted electrical signal, an equalizer 124 which converts the TIA-amplified electrical signal into a digital signal and adjusts a frequency response of the digital signal to reshape the adjusted digital signal into a desired form, an electrical signal regeneration unit 125 which recovers information including timing of the equalized signal, and an electrical signal interface unit 126 which delivers a recovered signal to the optical transmission equipment.

Here, the photoelectric conversion unit 122 and the transimpedance amplifier 123 may be implemented as a single block. Further, the equalizer 124 and the electrical signal regeneration unit 125 may be implemented as a single block.

The operation and management unit 130 is used to operate and manage internal blocks of the optical transceiver 100, such as the electrical signal regeneration units 112 and 125, and the light source driving unit 113.

The optical link monitoring unit 140 receives monitored values from the optical reception unit 120.

Here, according to an embodiment, the optical link monitoring unit 140 may identify the cause (for example, root cause) of faults in the optical link while distinguishing between loss and reflection by combining signal quality metrics with received optical power.

Here, the signal quality metrics may be extracted by the equalizer 124, and the received optical power may be acquired by the photodiode 122.

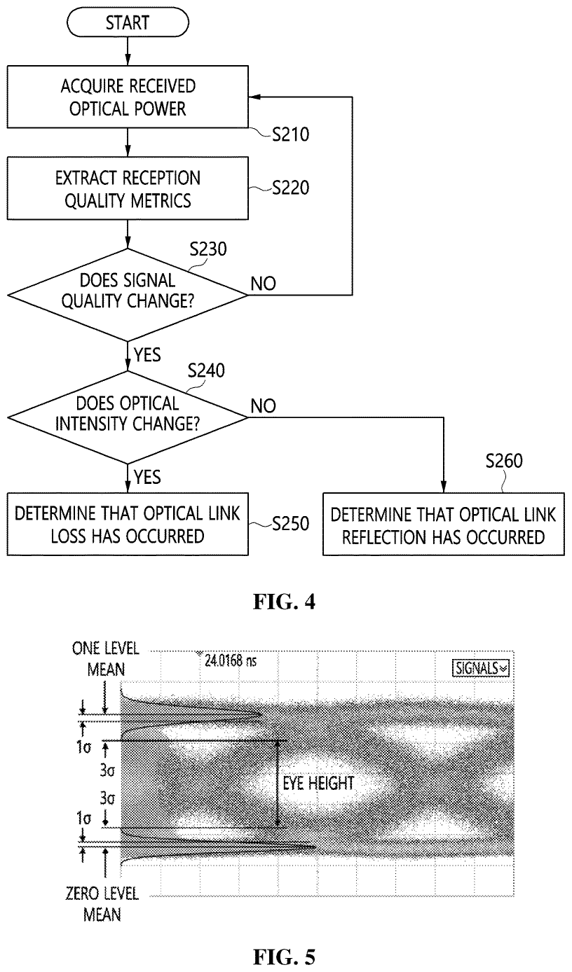

Detailed description of the optical link monitoring unit 140 will be made later with reference to FIGS. 4 to 10.

Here, the monitored value may include, for example, the operating current of the photodiode 122, a Received Signal Strength Indicator (RSSI), a Signal-to-Noise Ratio (SNR), an eye height, etc.

The optical link monitoring unit 140 delivers the monitored value from the optical reception unit 120 to the operation and management unit 130. The operation and management unit 130 delivers the results of monitoring the optical link (optical link monitoring results) to the optical transmission equipment using an I²C communication scheme.

The power supply unit 150 supplies power required for components included in the optical transceiver 100.

Then, an optical link monitoring method for monitoring changes in loss and quality of the optical link through the optical link monitoring unit 140 according to the embodiment will be described in detail.

FIG. 4 is a flowchart for explaining an optical link monitoring method according to an embodiment.

Referring to FIG. 4, the optical link monitoring method according to the embodiment may identify the cause (or root cause) of faults in the optical link by combining signal quality metrics with received optical power to distinguish between loss and reflection.

First, the optical link monitoring unit 140 acquires received optical power at step S210.

Here, according to an embodiment, the optical link monitoring unit 140 may monitor the variation in the intensity of the optical signal through the transimpedance amplifier 123.

That is, for example, by combining signal quality metrics extracted from equalizer with received optical power from the APD (Avalanche Photodiode) facilitates root-cause identification of ODN (Optical Distribution Network) faults, distinguishing between loss and reflection scenario.

In detail, the optical link monitoring unit 140 may monitor an RSSI value from the photodiode used as the photoelectric conversion unit 122 and the Transimpedance Amplifier (TIA) 123 connected thereto to perform a transimpedance amplification function, and may derive the variation in optical intensity using a pre-calculated equation.

In addition, according to another embodiment, the optical link monitoring unit 140 may monitor a current value from a power supply device directly connected to the photodiode 122, and may derive optical intensity using a pre-calculated equation.

Furthermore, according to a further embodiment, the optical link monitoring unit 140 may determine the variation in the intensity of the optical signal using the value of an Analog-to-Digital Converter (ADC) derived during a process of converting an analog electrical signal input to the equalizer 124 into a digital electrical signal.

Meanwhile, the optical link monitoring unit 140 monitors changes in the quality of the optical signal through the equalizer 124 at step S220.

That is, the optical transceiver 100 may perform in-operation Digital Signal Processor (DSP)-based feedforward sensing (FS) for detecting an Optical Distribution Network (ODN) fault scenario by monitoring digitally signal-processed (DSP) link quality parameters in the form of receiver-side equalization.

That is, various parameters may be acquired and monitored in real time by DSP without interrupting data traffic. For example, such parameters may include tap coefficients of the equalizer 124, ADC power (i.e., mean electrical power of a received signal expressed as a mean square relative to a full scale of the ADC), and Signal-to-Noise Ratio (SNR) of “1” and “0” levels in a received NRZ signal.

For this, according to an embodiment, the equalizer 124 analyzes the eye diagram of the input digital signal to extract histograms for respective levels. Further, after the magnitude and noise of the input digital signal are calculated, the equalizer 124 may be controlled to minimize the calculated noise.

By means of this process, the Signal-to-Noise Ratio (SNR) may be first measured. The SNR of the signal level is obtained by calculating the Mean-Squared Error (MSE) of each level at DSP output. A strong correlation between the measured Bit Error Rate (BER) and the SNR has been observed, indicating that the SNR may be a valid metric for predicting overall link quality.

Further, the eye height, which is a difference in intensity between a 0-level signal and a 1-level signal, may also be measured.

FIG. 5 is a diagram illustrating an example of a signal level and noise magnitude measured to calculate an SNR and an eye height in an eye diagram.

As described above, according to an embodiment, the types of state changes of an optical link to be distinguished are loss and reflectance.

Here, the change in the loss of the optical link may be monitored based on the variation in the intensity of the optical signal input to the optical reception unit 120.

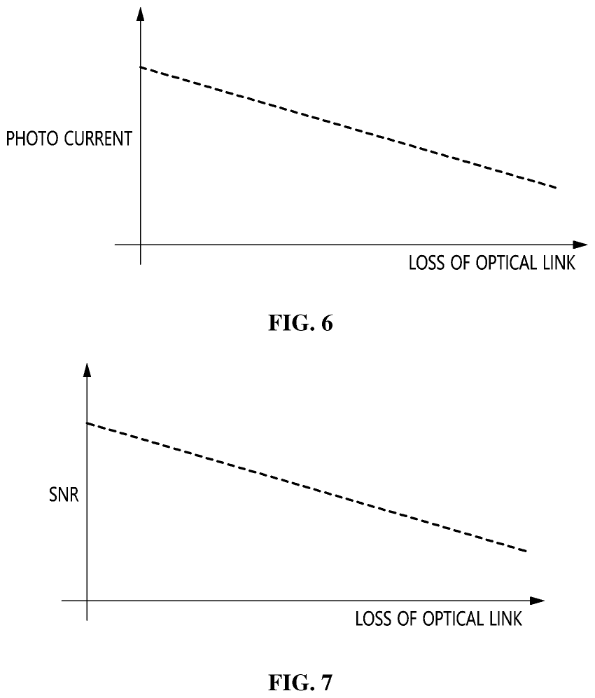

FIG. 6 is a diagram illustrating the change in the current value of a photodiode according to the change in optical link loss.

Referring to FIG. 6, as the loss of the optical link increases, the intensity of an optical signal input to the optical reception unit 120 decreases, and then the output current of the photodiode 122 also decreases.

FIG. 7 is a diagram illustrating an example of the SNR value of a monitored optical signal according to the change in optical link loss.

Referring to FIG. 7, as the optical link loss increases, the intensity of an optical signal input to the optical reception unit decreases, and thus the SNR value also decreases.

However, when the reflectance of the optical link changes, there is no variation in the intensity of the optical signal, and the noise of the optical signal increases.

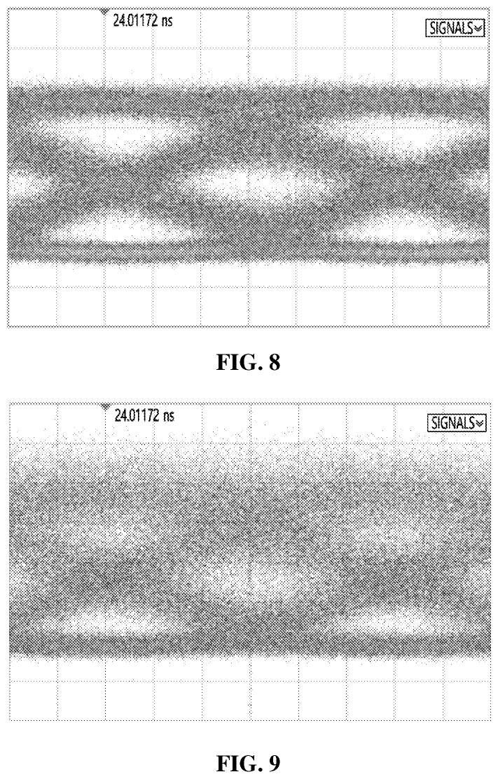

FIG. 8 illustrates an example of an eye diagram when reflection of an optical link is small, and FIG. 9 illustrates an example of an eye diagram when reflection of an optical link is large.

Referring to FIGS. 8 and 9, it can be seen that the mean intensities of two signals are identical to each other, but the qualities of the signals are different from each other.

Therefore, even if reflection increases, there is no change in the monitored current value of a photodiode, and thus the state of the change in reflectance cannot be detected based on the intensity of an optical signal.

However, even if input light intensities are identical to each other, when reflectance increases compared to the case of FIG. 8, the noise of the signal in FIG. 9 increases, and thus the SNR or the like measured by the equalizer 124 may be changed.

In an embodiment, by utilizing these characteristics, the change in the reflectance of an optical link may be detected.

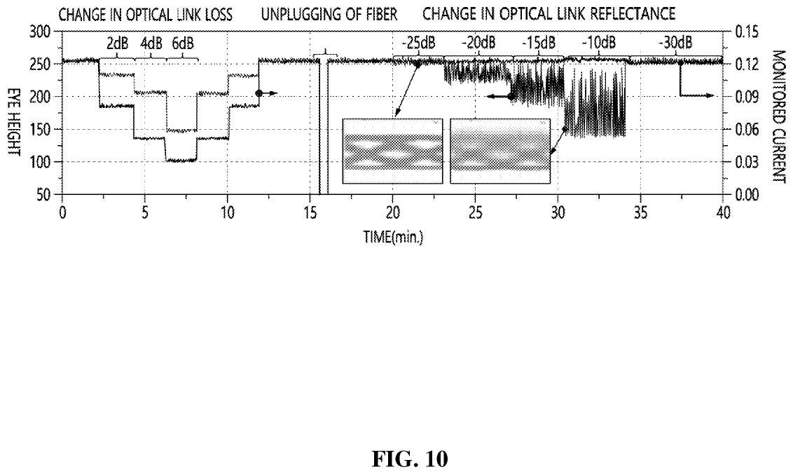

FIG. 10 is a diagram illustrating an example of the results of simultaneously measuring monitored current and eye height with respect to the change in loss and reflectance of an optical link.

Referring to FIG. 10, the results of measuring eye height and monitored current in the case where the loss of the optical link changes are illustrated on the left side of the drawing. It can be seen that, as the loss of the optical link changes, both the eye height and the monitored current change.

Here, it can be seen that, when the signal of the optical link is interrupted (unplugging of fiber), neither of the two values is measured.

In addition, on the right side of the drawing, the two values are measured in the case where the reflectance of the optical link changes. It can be seen that, although the reflectance changes, the difference between the values of the monitored current is negligible, but the difference between the values of the eye height is significant.

Therefore, the change in reflectance of the optical link cannot be detected from the results of measuring the variation in optical signal intensity using the monitored current. However, when both the variation in optical signal intensity and the change in quality of the optical signal are monitored simultaneously as in the embodiment, the change in loss and the change in reflectance of the optical link may be distinguished from each other.

The following Table 1 shows whether the changes in the state of the optical link are distinguished according to the optical link monitoring method.

TABLE 1

| | Optical link | Optical link | Distinguish- |
|---|---|---|---|
| Monitoring item | loss | reflectance | ability |
| Optical signal intensity | Detected | Not detected | Not distinguished |
| Optical signal intensity | Detected | Detected | Distinguished |
| and quality | | | |

Referring to Table 1, the reflectance of the optical link cannot be detected using the intensity of the optical signal.

However, according to an embodiment, the optical link monitoring unit 140 may identify the cause of faults in the optical link while distinguishing between optical link loss and optical link reflectance by combining the optical signal intensity, that is, optical power, with the optical signal quality and performing determination.

Referring back to FIG. 4, when both signal quality and received optical power change at steps S230 and S240, the optical link monitoring unit 140 according to an embodiment may determine that the loss of the optical link has occurred at step S250.

However, when only signal quality changes without the change in optical power at steps S230 and S240, the optical link monitoring unit 140 may determine that the reflection of the optical link has occurred at step S260.

Here, the optical link monitoring unit 140 may determine faults from the results of monitoring the optical link based on pre-trained artificial intelligence.

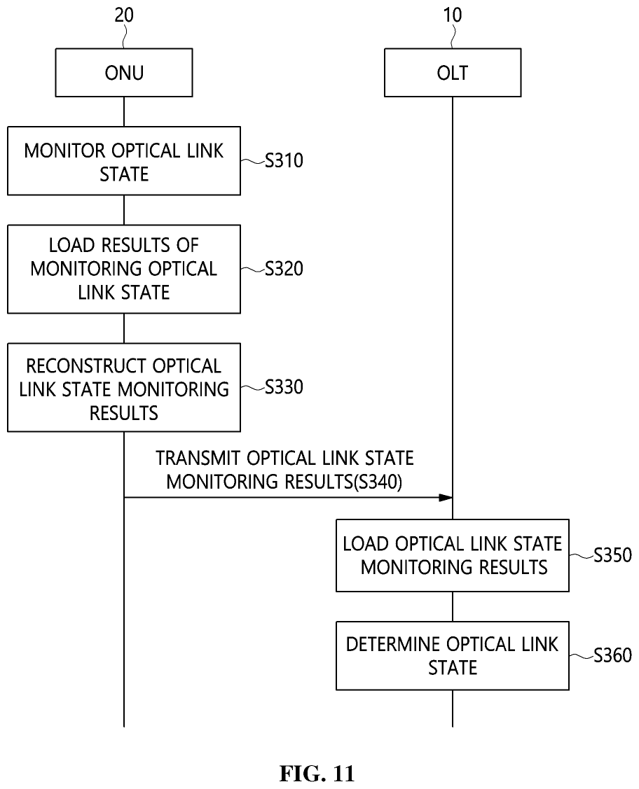

FIG. 11 is a signal flowchart for explaining a method for transmitting/receiving the results of monitoring an optical link between optical transmission devices according to another embodiment.

Referring to FIG. 11, an optical transceiver first monitors an optical link at step S310.

The optical transmission equipment (B) 20 loads optical link (state) monitoring results including the results of monitoring changes in the quality and intensity of an optical signal from the optical transceiver at step S320.

Here, the optical link monitoring results (state information) of the optical transceiver read by the optical transmission equipment (B) 20 through the optical transceiver may include transmitted optical power (Tx Power), received optical power (Rx Power), laser bias current, module temperature, module voltage, and quality information of the received optical signal (SNR, eye height, and the like).

Then, the optical transmission equipment (B) 20 reconstructs the optical link monitoring results to conform to a predefined data format (specification) at step S330.

The optical transmission equipment (B) 20 transmits data including the optical link monitoring results to the optical transmission equipment (A) 10 using the optical transceiver at step S340.

The optical transmission equipment (A) 10 receives the data transmitted from the second optical transmission equipment (B) 20, and loads the optical link monitoring results at step S350.

The second optical transmission equipment (A) 10 determines the state of the optical link using monitoring results of other systems together with the optical link monitoring results of the optical transmission equipment (B) 20 at step S360.

Here, system monitoring items may refer to all items used when a system operator operates an optical communication system.

For example, the system monitoring items may be items used by Ethernet optical transmission equipment or TDM-PON optical transmission equipment.

Furthermore, when determining faults using the optical link monitoring results, such determination may be processed with the help of a device that uses pre-trained artificial intelligence.

Through the above-described scheme, an optical link monitoring signal may also be delivered from the optical transmission equipment (A) 10 to the optical transmission equipment (B) 20.

Furthermore, when the optical transmission equipment (A) 10 transmits the monitoring results to the optical transmission equipment (B) 20, protocols related to the management operation of the Ethernet or TDM-PON may be used as the protocol thereof. In particular, an ONT Management and Control Interface (OMCI) or Physical Layer Operations, Administration and Maintenance (PLOAM) that is a standard interface for managing and controlling optical network terminals in the PON may be used.

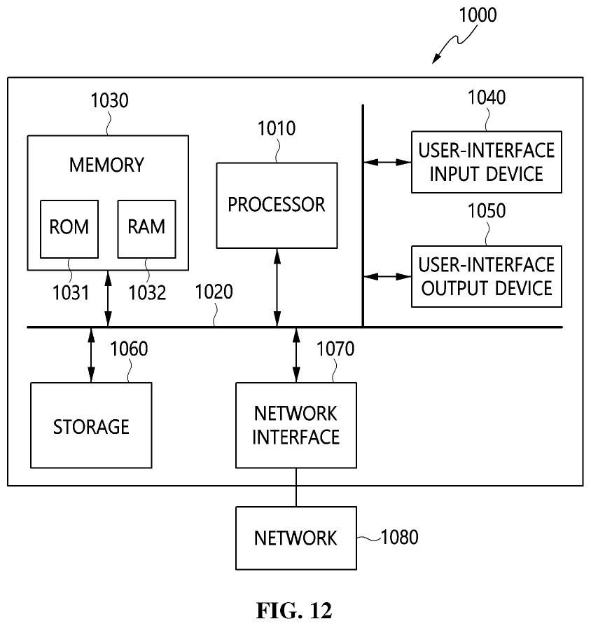

FIG. 12 is a diagram illustrating the configuration of a computer system according to an embodiment.

An optical link monitoring apparatus according to an embodiment may be implemented in a computer system 1000 such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to embodiments, it is possible to detect not only changes in optical link loss but also changes in reflectance using an optical transceiver that is employed in an optical transmitting/receiving device.

According to embodiments, it may be possible to exchange the results of measuring state changes of an optical link between optical transmission/reception devices and rapidly diagnose faults in the optical link using the exchanged results.

Although the embodiment of the present disclosure has been disclosed, those skilled in the art will appreciate that the present disclosure can be implemented as other concrete forms, without departing from the scope and spirit of the disclosure as disclosed in the accompanying claims. Therefore, it should be understood that the embodiment is only for illustrative purpose and does not limit the scope of the present disclosure.

What is claimed is:

1. An optical link monitoring method, comprising:
identifying a root cause of faults in an optical link by combining signal quality metrics with received optical power to distinguish between loss and reflection.

2. The optical link monitoring method of claim 1, wherein the signal quality metrics are extracted by an equalizer.

3. The optical link monitoring method of claim 1, wherein the received optical power is acquired based on a photodiode.

4. The optical link monitoring method of claim 1, wherein the signal quality metrics include at least one of an amplitude, a Signal-to-Noise Ratio (SNR) or an eye height of a received optical signal, or a combination thereof.

5. The optical link monitoring method of claim 1, further comprising:
when both signal quality and optical power change, determining that loss of the optical link has occurred; and
when only signal quality changes without a change in optical power, determining that reflection of the optical link has occurred.

6. The optical link monitoring method of claim 1, wherein:
the signal quality metrics and the received optical power are acquired from an optical reception unit,
the optical reception unit comprises:
a photodiode configured to convert a received optical signal into an electrical signal; and
an equalizer configured to convert the electrical signal into a digital signal, adjust a frequency response of the digital signal, and then reshape the adjusted digital signal in a desired form,
the equalizer extracts the signal quality metrics, and
the photodiode acquires the received optical power.

7. The optical link monitoring method of claim 2, wherein the equalizer is configured to extract histograms for respective levels by analyzing an eye diagram of an input digital signal, calculate an intensity and noise of the input digital signal based on the histograms for respective levels, and then measure a Signal-to-Noise Ratio (SNR) or an eye height.

8. The optical link monitoring method of claim 7, wherein the equalizer is controlled to minimize the noise.

9. An optical link monitoring apparatus, comprising:
a memory configured to store at least one program; and
a processor configured to execute the program,
wherein the program is configured to identify a root cause of faults in an optical link by combining signal quality metrics with received optical power to distinguish between loss and reflection.

10. The optical link monitoring apparatus of claim 9, wherein the signal quality metrics are extracted by an equalizer.

11. The optical link monitoring apparatus of claim 9, wherein the received optical power is acquired by a photodiode.

12. The optical link monitoring apparatus of claim 9, wherein the signal quality metrics include at least one of an amplitude, a Signal-to-Noise Ratio (SNR) or an eye height of an optical signal, or a combination thereof.

13. The optical link monitoring apparatus of claim 9, wherein the program is configured to:
when both signal quality and optical power change, determine that loss of the optical link has occurred; and
when only signal quality changes without a change in optical power, determine that reflection of the optical link has occurred.

14. The optical link monitoring apparatus of claim 9, wherein:
the signal quality metrics and the received optical power are acquired from an optical reception unit,
the optical reception unit comprises:
a photodiode configured to convert a received optical signal into an electrical signal; and
an equalizer configured to convert the electrical signal into a digital signal, adjust a frequency response of the digital signal, and then reshape the adjusted digital signal in a desired form,
the equalizer extracts the signal quality metrics, and
the photodiode acquires the received optical power.

15. The optical link monitoring apparatus of claim 10, wherein the equalizer is configured to extract histograms for respective levels by analyzing an eye diagram of an input digital signal, calculate an intensity and noise of the input digital signal based on the histograms for respective levels, and then measure a Signal-to-Noise Ratio (SNR) or an eye height.

16. The optical link monitoring apparatus of claim 15, wherein the equalizer is controlled to minimize noise.

17. The optical link monitoring apparatus of claim 15, wherein the program is configured to determine faults from a result of monitoring the optical link based on pre-trained artificial intelligence.

18. A method for monitoring an optical link between optical transmission devices, comprising:
monitoring, by an optical transceiver of first optical transmission equipment, an optical link;
loading, by the first optical transmission equipment, an optical link monitoring result related to changes in optical signal quality and optical signal intensity from the optical transceiver;
reconstructing, by the first optical transmission equipment, the optical link monitoring result to conform to a predefined data format;
transmitting, by the first optical transmission equipment, data including the optical link monitoring result to second optical transmission equipment;
receiving, by the second optical transmission equipment, the data and loading the optical link monitoring result; and
determining, by the second optical transmission equipment, a state of the optical link using the optical link monitoring result.

19. The method of claim 18, wherein the optical link monitoring result loaded from the optical transceiver includes transmitted optical power (Tx Power), received optical power (Rx Power), a laser bias current, a module temperature or a module voltage, or a combination thereof.

20. The method of claim 18, wherein:
the optical link monitoring result further includes quality information of a received optical signal, and
the quality information of the received optical signal includes at least one of a Signal-to-Noise Ratio (SNR) or an eye height, or a combination thereof.
